(19) United States
(12) Patent Application Publication
(10) Pub. No.: US 2023/0190027 A1
(43) Pub. Date: Jun. 22, 2023

(54) Fruit Juicer Assembly

(71) Applicant: Randy Rogahn, Las Vegas, NV (US)

(72) Inventor: Randy Rogahn, Las Vegas, NV (US)

(21) Appl. No.: 17/552,527

(22) Filed: Dec. 16, 2021

(51) Int. Cl. A47J 19/02

(52) U.S. Cl. CPC A47J 19/02

(57) ABSTRACT

A fruit juicer assembly for squeezing juice from a piece of fruit includes a spear for penetrating a piece of fruit. The spear is comprised of a fluid impermeable material to facilitate juice from the piece of fruit to flow downwardly along the spear thereby facilitating the juice to be directed into a cocktail. A juicer is coupled to the spear and the juicer is urgeable into a closed position to compress the piece of fruit. In this way juice can be squeezed from the piece of fruit such that the juice runs down the spear and into the cocktail. The juicer is comprised of a fluid impermeable material to inhibit the juice from passing through the juicer.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to juicer devices and more particularly pertains to a new juicer device for squeezing juice from a piece of fruit. The device includes a spear and a juicer, shaped like an umbrella, which is disposed on the spear. Each of the spear and the juicer is comprised of a fluid impermeable material to inhibit the juice from being absorbed. In this way the juice can run down the spear to be deposited into a cocktail.

### Description of Related Art Including Information Disclosed Under 37 CFR 1.97 And 1.98.

The prior art relates to juicer devices including a juicer comprising a cup that insertably receives a piece of fruit and a lid that is hingedly coupled to the cup for squeezing juice from the piece of fruit. The prior art discloses a juicer comprising a first handle that is hingedly coupled to a second handle which can be compressed together for squeezing juice from a piece of fruit. The prior art discloses a juice which includes a reamer that insertably receives a knife blade for dissecting juicing a piece of fruit. The prior art discloses a pineapple squeezer comprising a cup and a corrugated prominence in the cup for squeezing a pineapple.

### (H) BRIEF SUMMARY OF THE INVENTION

An embodiment of the disclosure meets the needs presented above by generally comprising a spear for penetrating a piece of fruit. The spear is comprised of a fluid impermeable material to facilitate juice from the piece of fruit to flow downwardly along the spear thereby facilitating the juice to be directed into a cocktail. A juicer is coupled to the spear and the juicer is urgeable into a closed position to compress the piece of fruit. In this way juice can be squeezed from the piece of fruit such that the juice runs down the spear and into the cocktail. The juicer is comprised of a fluid impermeable material to inhibit the juice from passing through the juicer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front view of a fruit juicer assembly according to an embodiment of the disclosure showing a juicer in a closed position.

FIG. 2 is a front view of an embodiment of the disclosure showing a juice in an open position.

FIG. 3 is a bottom view of an embodiment of the disclosure.

FIG. 4 is a top perspective view of an embodiment of the disclosure.

FIG. 5 is a bottom perspective view of an embodiment of the disclosure.

FIG. 6 is a perspective in-use view of an embodiment of the disclosure showing a piece of fruit being slid onto a spear.

FIG. 7 is a bottom perspective in-use view of an embodiment of the disclosure.

FIG. 8 is a perspective in-use view of an embodiment of the disclosure showing a piece of fruit being squeezed.

FIG. 9 is a perspective in-use view of an embodiment of the disclosure showing juice being directed into a cocktail.

### (J) DETAILED DESCRIPTION OF THE INVENTION

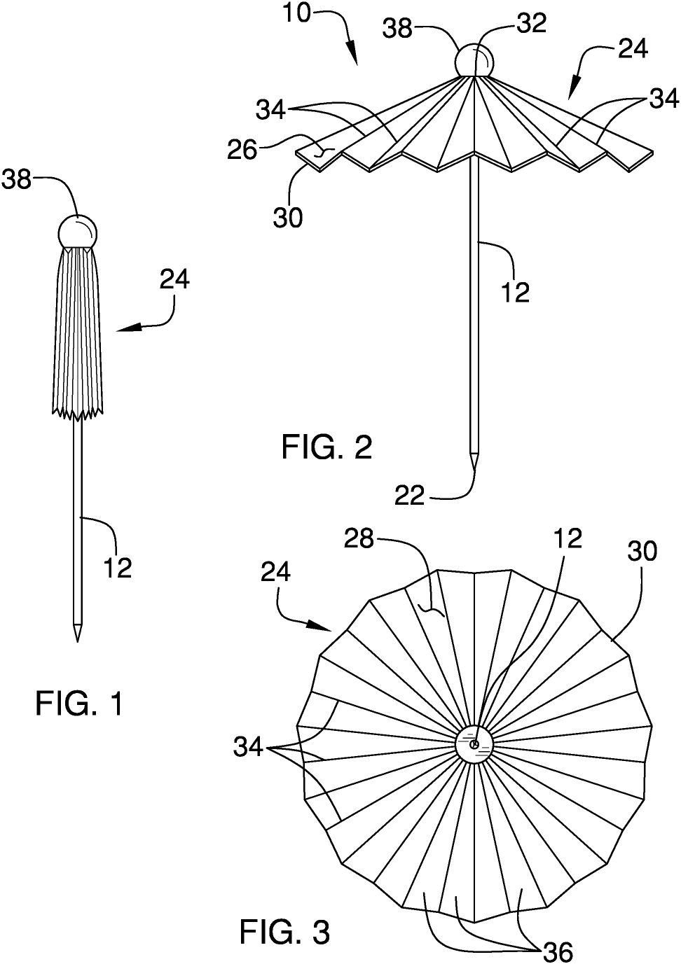

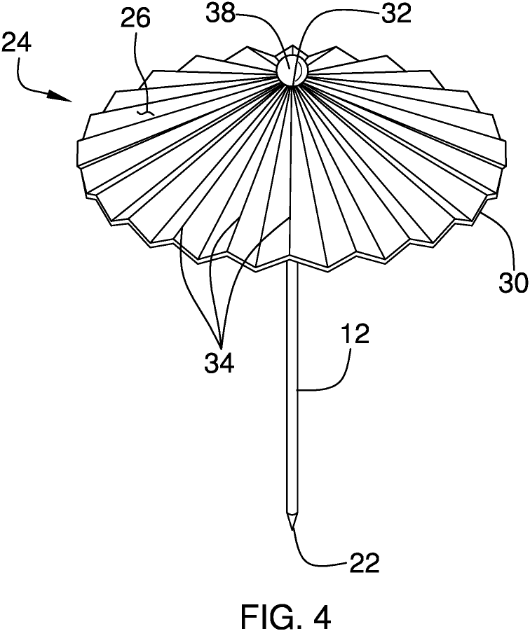

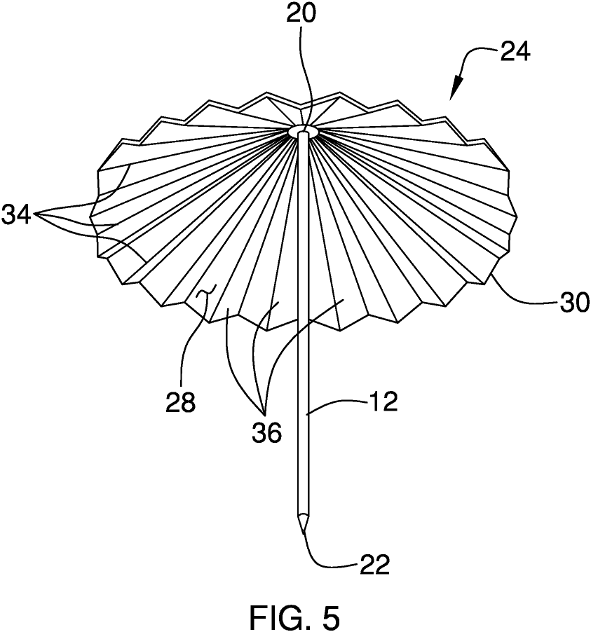

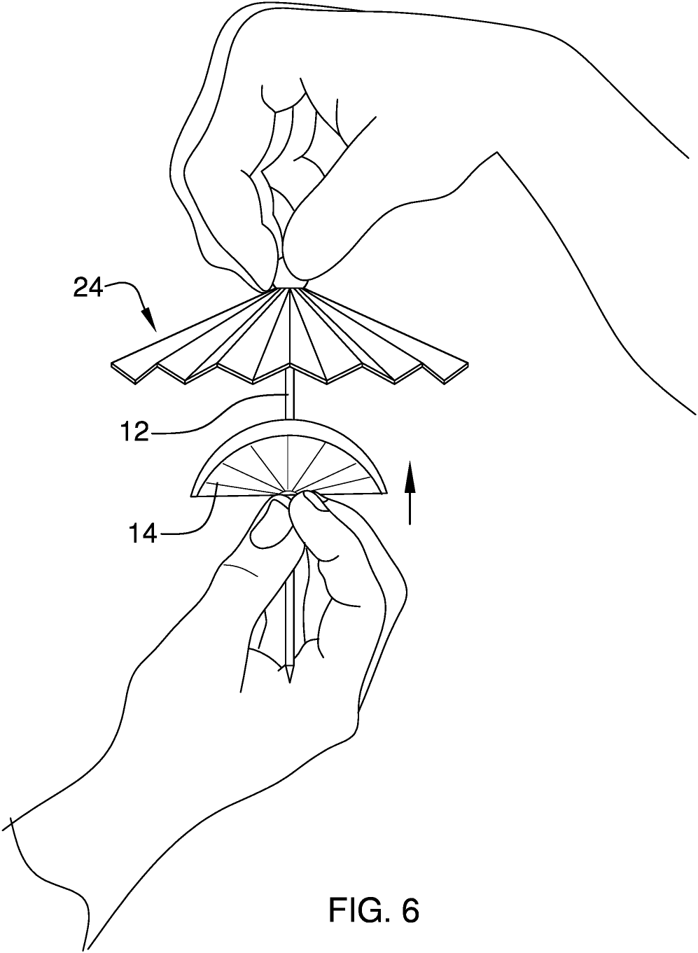

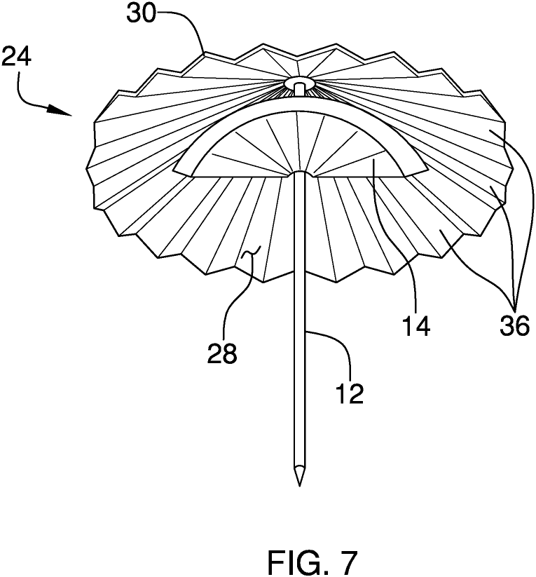

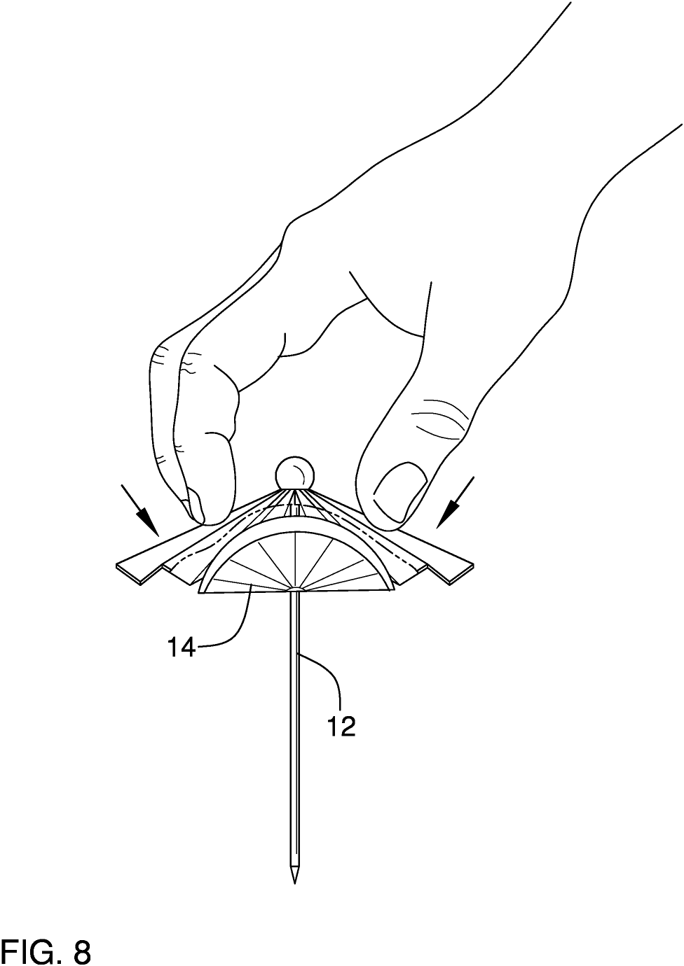

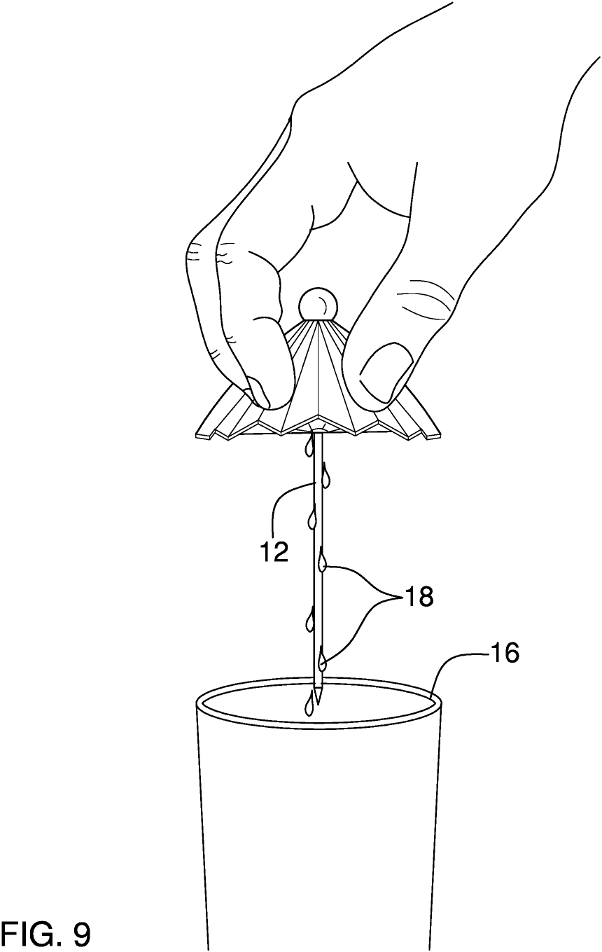

With reference now to the drawings, and in particular to FIGS. 1 through 9 thereof, a new juicer device embodying the principles and concepts of an embodiment of the disclosure and generally designated by the reference numeral 10 will be described.

As best illustrated in FIGS. 1 through 9, the fruit juicer assembly 10 generally comprises a spear 12 that is comprised of a rigid material such that the spear 12 can penetrate a piece of fruit 14. The piece of fruit 14 may be a slice of lemon, a slice of lime or a slice of any other fruit that is commonly employed to garnish or flavor a cocktail 16. The spear 12 is comprised of a fluid impermeable material, including but not being limited to, plastic or steel. In this way the juice 18 from the piece of fruit 14 can flow downwardly along the spear 12 thereby facilitating the juice 18 to be directed into a cocktail 16. The spear 12 has a top end 20 and a bottom end 22, and the bottom end 22 tapers to a point to penetrate the piece of fruit 14.

A juicer 24 is coupled to the spear 12 and the juicer 24 is biased into an open position to accommodate the piece of fruit 14 when the piece of fruit 14 is positioned on the spear 12. The juicer 24 is urgeable into a closed position to compress the piece of fruit 14 thereby facilitating juice 18 to be squeezed from the piece of fruit 14. The juicer 24 is comprised of a fluid impermeable material to inhibit the juice 18 from passing through the juicer 24. Furthermore, the juicer 24 is comprised of a rigid material, such as plastic or the like, to resist being deformed by the piece of fruit 14 when the piece of fruit 14 is being squeezed.

The juicer 24 has a top surface 26, a bottom surface 28 and a perimeter edge 30 extending between the top surface 26 and the bottom surface 28, and the perimeter edge 30 is continuously arcuate about a center point 32 of the juicer 24 such that the juicer 24 has a disk shape. The juicer 24 has a plurality of fold lines 34 each extending between the center point and the perimeter edge 30 such that the plurality of fold lines 34 defines a plurality of sections 36 of the juicer 24. Additionally, the fold lines 34 are spaced apart from each other and radiate outwardly from the center point such that each of the sections 36 of the juicer 24 has a tapering width between the perimeter edge 30 and the center point 32.

The juicer 24 is folded along each of the fold lines 34 when the juicer 24 is urged into the closed position having perimeter edge 30 being directed downwardly along the spear 12. In this way the bottom surface 28 can compress the piece of fruit 14 when the juicer 24 is urged into the closed position. The juicer 24 is substantially unfolded along each of the fold lines 34 when the juicer 24 is biased into the open position such that the juicer 24 forms a cone on the spear 12 having the perimeter edge 30 being spaced outwardly from the spear 12. Furthermore, each of the sections 36 of the juicer 24 is oriented at an obtuse angle with an adjacent one of the sections 36 when the juicer 24 is in the open position, and each of the sections 36 alternately slopes upwardly and downwardly around the spear 12.

The top end 20 of the spear 12 is coupled to the bottom surface 28 of the juicer 24 and the top end 20 is aligned with the center point 32 of the juicer 24. A ball 38 is coupled to the juicer 24 and the ball 38 can be gripped. The ball 38 is positioned on the top surface 26 of the juicer 24 and the ball 38 is aligned with the center point 32 of the juicer 24. The ball 38 has a diameter that is sufficient to facilitate the ball 38 to be gripped with a person’s fingers.

In use, the spear 12 is extended through the piece of fruit 14 and the spear 12 is directed into the cocktail 16. The juicer 24 is urged into the closed position to compress the piece of fruit 14 thereby facilitating juice 18 to be squeezed from the piece of fruit 14. Thus, the juice 18 runs down the spear 12 and into the cocktail 16. In this way the juice 18 can be squeezed from the piece of fruit 14 and dispensed into the cocktail 16 without requiring a user to touch the piece of fruit 14. The spear 12 can be placed in the cocktail 16 to facilitate the piece of fruit 14 to garnish the cocktail 16 or the spear 12 can be discarded along with the piece of fruit 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fruit juicer assembly for squeezing juice from a fruit into a cocktail, said assembly comprising:
a spear being comprised of a rigid material wherein said spear is configured to penetrate a piece of fruit, said spear being comprised of a fluid impermeable material wherein said spear configured to facilitate juice from the piece of fruit to flow downwardly along said spear thereby facilitating the juice to be directed into a cocktail;
a juicer being coupled to said spear, said juicer being biased into an open position wherein said juicer is configured to accommodate the piece of fruit when the piece of fruit is positioned on said spear, said juicer being urgeable into a closed position wherein said juicer is configured to compress the piece of fruit thereby facilitating juice to be squeezed from the piece of fruit, said juicer being comprised of a fluid impermeable material wherein said juicer is configured to inhibit the juice from passing through said juicer, said juicer being comprised of a rigid material wherein said juicer is configured to resist being deformed by the piece of fruit when the piece of fruit is being squeezed; and
a ball being coupled to said juicer wherein said ball is configured to be gripped.

2. The assembly according to claim 1, wherein:
said juicer has a top surface, a bottom surface and a perimeter edge extending between said top surface and said bottom surface, said perimeter edge being continuously arcuate about a center point of said juicer such that said juicer has a disk shape, said juicer having a plurality of fold lines each extending between said center point and said perimeter edge such that said plurality of fold lines defines a plurality of sections of said juicer; and
said spear has a top end and a bottom end, said bottom end tapering to a point wherein said spear is configured to penetrate the piece of fruit, said top end of said spear being coupled to said bottom surface of said juicer, said top end being aligned with said center point of said juicer.

3. The assembly according to claim 2, wherein said fold lines are spaced apart from each other and radiate outwardly from said center point such that each of said sections of said juicer has a tapering width between said perimeter edge and said center point.

4. The assembly according to claim 2, wherein said juicer is folded along each of said fold lines when said juicer is urged into said closed position having perimeter edge being directed downwardly along said spear wherein said bottom surface is configured to compress the piece of fruit.

5. The assembly according to claim 2, wherein said juicer is substantially unfolded along each of said fold lines when said juicer is biased into said open position such that said juicer forms a cone on said spear having said perimeter edge being spaced outwardly from said spear.

6. The assembly according to claim 5, wherein each of said sections of said juicer is oriented at an obtuse angle with an adjacent one of said sections when said juicer is in said open position having each of said sections alternately sloping upwardly and downwardly around said spear.

7. The assembly according to claim 1, wherein said ball is positioned on said top surface of said juicer, said ball being aligned with said center point of said juicer.

8. A fruit juicer assembly for squeezing juice from a fruit into a cocktail, said assembly comprising:
a spear being comprised of a rigid material wherein said spear is configured to penetrate a piece of fruit, said spear being comprised of a fluid impermeable material wherein said spear configured to facilitate juice from the piece of fruit to flow downwardly along said spear thereby facilitating the juice to be directed into a cocktail, said spear having a top end and a bottom end, said bottom end tapering to a point wherein said spear is configured to penetrate the piece of fruit;
a juicer being coupled to said spear, said juicer being biased into an open position wherein said juicer is configured to accommodate the piece of fruit when the piece of fruit is positioned on said spear, said juicer being urgeable into a closed position wherein said juicer is configured to compress the piece of fruit thereby facilitating juice to be squeezed from the piece of fruit, said juicer being comprised of a fluid impermeable material wherein said juicer is configured to inhibit the juice from passing through said juicer, said juicer being comprised of a rigid material wherein said juicer is configured to resist being deformed by the piece of fruit when the piece of fruit is being squeezed, said juicer having a top surface, a bottom surface and a perimeter edge extending between said top surface and said bottom surface, said perimeter edge being continuously arcuate about a center point of said juicer such that said juicer has a disk shape, said juicer having a plurality of fold lines each extending between said center point and said perimeter edge such that said plurality of fold lines defines a plurality of sections of said juicer, said fold lines being spaced apart from each other and radiating outwardly from said center point such that each of said sections of said juicer has a tapering width between said perimeter edge and said center point, said juicer being folded along each of said fold lines when said juicer is urged into said closed position having perimeter edge being directed downwardly along said spear wherein said bottom surface is configured to compress the piece of fruit, said juicer being substantially unfolded along each of said fold lines when said juicer is biased into said open position such that said juicer forms a cone on said spear having said perimeter edge being spaced outwardly from said spear, each of said sections of said juicer being oriented at an obtuse angle with an adjacent one of said sections when said juicer is in said open position having each of said sections alternately sloping upwardly and downwardly around said spear, said top end of said spear being coupled to said bottom surface of said juicer, said top end being aligned with said center point of said juicer; and
a ball being coupled to said juicer wherein said ball is configured to be gripped, said ball being positioned on said top surface of said juicer, said ball being aligned with said center point of said juicer.
